(19) United States
(12) Patent Application Publication
(10) Pub. No.: US 2015/0290926 A1
(43) Pub. Date: Oct. 15, 2015

(54) Apparatus to print on water-soluble film

(71) Applicant: The Procter & Gamble Company, Cincinnati, OH (US)

(72) Inventors: Andrea BRANCA, Pescara (IT); Miguel BRANDT SANZ, Tervuren (BE); Andrea GABRIELE, Brussels (BE)

(21) Appl. No.: 14/685,616

(22) Filed: Apr. 14, 2015

(30) Foreign Application Priority Data
Apr. 14, 2014 (EP) 14164578.8
Mar. 27, 2015 (EP) 15161338.7

(51) Int. Cl. B41F 5/24

(52) U.S. Cl. CPC B41F 5/24

(57) ABSTRACT

Apparatus for producing a printed film, the apparatus including a roll of water-soluble film to be printed, the film including a resin that includes polyvinyl alcohol (PVOH) or a copolymer thereof, a rotating drum, a printing system for printing a printed pattern onto the film, the printing system including a plurality of separate printing stations arranged on the rotating drum. Printed films made from the apparatus.

### FIELD OF THE INVENTION

The present invention relates to the field of printing onto water-soluble film comprising polyvinyl alcohol (PVOH) resin.

### BACKGROUND OF THE INVENTION

Printing on water-soluble film comprising polyvinyl alcohol (PVOH) resin is desired. A printed pattern may be obtained by printing compounds such as ink and dyes to form the printed pattern on the film. In particular, it may be desired that the printed pattern is printed from more than one printing stations, for example each station printing a different color. Due to the physical and chemical properties of film comprising PVOH, the adjustment of a printed pattern which has been printed by several printing stations has been found challenging and misalignment between the parts of the pattern which have been printed may be observed.

### SUMMARY OF THE INVENTION

The inventors have discovered that effective printing on a water-soluble film comprising PVOH resin could be achieved by an apparatus according to the invention.

The present disclosure concerns an apparatus for producing a printed film, the apparatus comprising:
a roll of water-soluble film to be printed, the film comprising a resin comprising polyvinyl alcohol (PVOH) or a copolymer thereof,
a rotating drum,
a printing system for printing a printed pattern onto the film, the printing system comprising a plurality of separate printing stations arranged on the rotating drum.

Even if the visco-elastic material properties of the PVOH film make it challenging, the apparatus of the present disclosure may provide a film printed by several printing stations with an improved quality of the printed pattern. Parts of the pattern which have been printed by different printing stations (for example the different colours of a printed image) may exhibit an improved registration (phasing). Also, due to the presence of the drum, the printing system may also be more space efficient compared to a classical sequenced horizontal mode. The drum of the invention may help to provide a more constant tension or elongation to the film during the printing process.

The present disclosure also concerns a printed film made with the apparatus of the invention. The present disclosure also concerns a pouch made with the film made with the apparatus of the invention.

### DESCRIPTION OF THE DRAWINGS

FIG. 1 is a schematic view of an apparatus according to the invention

FIG. 2 is a schematic view of a flexographic printing station on the drum

FIG. 3 is a schematic view of an apparatus according to the invention

### DETAILED DESCRIPTION OF THE INVENTION

The Apparatus

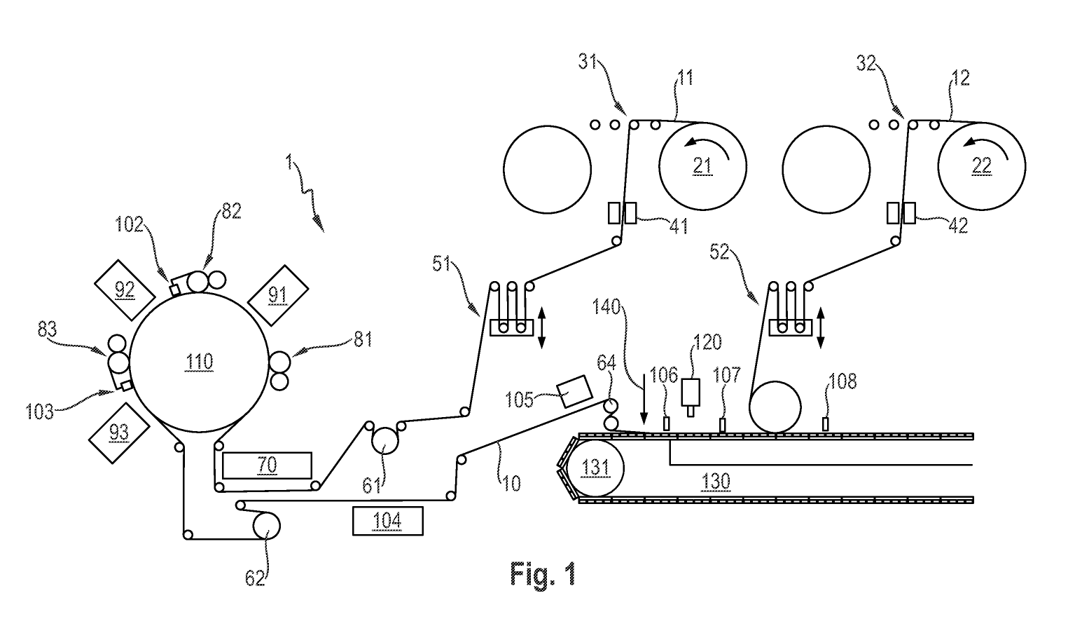

As shown on FIG. 1 the apparatus (1) comprises a roll (21) of film to be printed. The film (11) comprises polyvinylalcohol or a copolymer thereof. The film may be unwound from a spindle or a reel. The apparatus may comprise a film unwinder (31). The apparatus may comprise an automatic splicer (41). The apparatus may comprise an accumulator/dancer system (51) for control of the unwind tension and speed. The tension and the metering velocity may be controlled on the in-feed of the printing unit by utilizing an in-feed driven roller (61) which may or not be coupled in a control loop with tension measurement load cells. The apparatus may comprise a film pre-treatment station (70). The film pre-treatment station may provide corona treatment for increased spreadability and/or deposition of the compound to be printed (e.g. dye or ink). The apparatus comprises a rotating drum (110). The apparatus comprises a printing system (80) for printing onto the film. The printing system comprises a plurality of separate printing stations (81, 82, 83). The printing system may comprise at least two, or at least three printing stations. Two or more of the printing stations are arranged on the rotating drum. The apparatus may comprise one or more, for example at least two, for example at least three drying and/or curing station (91, 92, 93). The drying and/or curing station may be arranged on the rotating drum. The apparatus may comprise two or more driven rollers (61, 62, 64). The apparatus may comprise an in-feed driven roller (61) before the printing system. The apparatus may comprise an out-feed driven roller (62, 64) after the printing system. The apparatus may comprise a registration sensor (102, 103, 104, 105, 106, 107, 108) for controlling the quality and the registration of the printed pattern. The apparatus may comprise an endless rotating system such as a conveyor belt (130). The apparatus may comprise a pouch-making unit. The pouch-making unit may include a filling system (120) to fill a pouch. The pouch may comprise the printed film and an additional layer of film. The additional layer of film can be provided by a roll (22) of additional layer of layer film (12), an unwinder (32), a splicer (42) and/or an accumulator/dancer system (52).

The additional layer of film (12) may also be printed. The additional layer of film may be printed using a system comprising some or all of equivalent equipments used to print the other layer. In particular, the additional layer of layer film may be printed using a system comprising a rotating drum and a printing system comprising a plurality of separate printing stations arranged on the rotating drum.

On FIG. 1 is illustrated a rotating drum on which three flexographic printing stations are arranged. Flexography printing is the direct transfer of liquid ink to substrate from a photopolymer image carrier. Any one or more of these printing stations can be replaced with a different printing technology. One or more of the printing station may be a digital printing station such as drop on demand inkjet, piezo inkjet, and thermal inkjet, thermal transfer printing station and/or tonejet printing station.

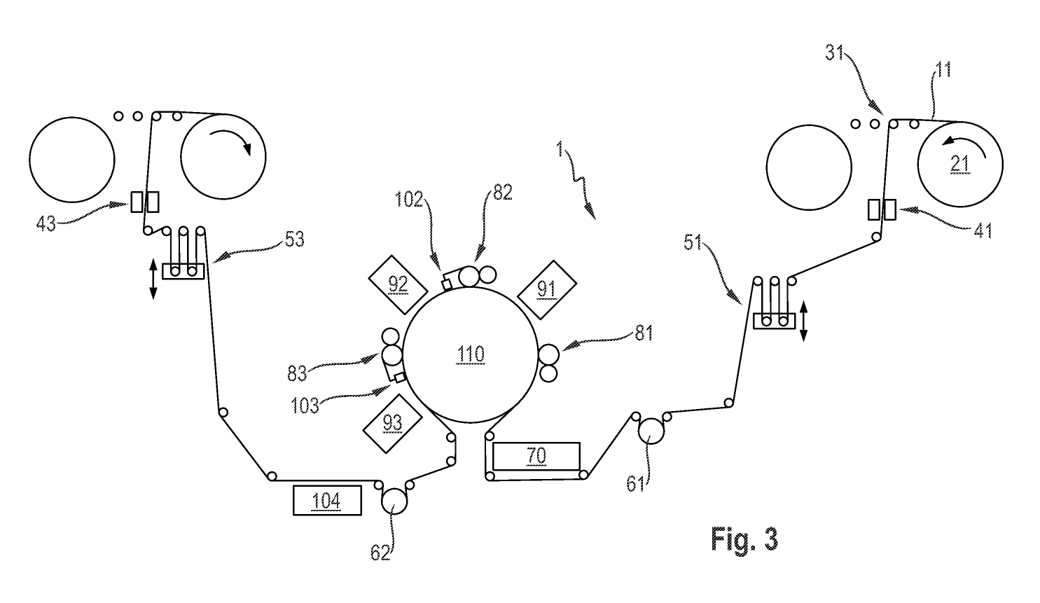

As shown on FIG. 3 the apparatus may comprise a film re-winder (33), a splicer (43), an accumulator/dancer system (53) to rewind the printed film on a roll (23).

The Rotating Drum

The apparatus comprises a rotating drum.

In order to maintain a good registration accuracy between the several printing stations and given the visco-elastic material properties of the film comprising PVOH, the printing system requires good control of both tension and speed of the film.

The use of a rotating drum may offer the benefit of controlled tension and elongation conditions all along the printing process. This allows for higher color to color registration accuracy, constant tension during the printing process and the process becomes insensitive to material property changes such as creep and relaxation.

The rotating drum may hold the film in place by friction, preventing any undesired displacement of the film between each of the printing stations.

Without wishing to be bound by theory, soluble films and, particularly, PVOH films are highly hygroscopic and sensitive to environment moisture and temperature conditions. In a printing system composed of multiple flexographic stations, the PVOH film would elongate and deform in the spans between stations, leading also to tracking variation and other web handling problems like wrinkles or curling. Additionally, PVOH films tend to present creep and relaxation behaviour, meaning that the material will elongate over time when subject to a constant tension. For example, when the production system is stopped the film will lose tension on any free web spans and the material in those spans will have a higher color to color placement variation and may have to be rejected or scrapped. As a result of this, it would be very difficult to maintain an accurate positioning of the successive print patterns.

In a central drum system, the film is locked by friction on a defined position on the surface of the drum and its position is precisely maintained through the different printing stations. This way, it is possible to overcome the limitations described above (unsupported web) and obtain much more accurate position of the different elements of the image (standard deviation of color-to-color registration can be less than 200 μm), even with very elastic materials.

This accurate positioning is maintained also when the line stops.

The Printing System

The printing system comprises two or more printing stations, for example three or more printing stations. Some or all of the printing stations are arranged on a rotating drum. At least two, for example at least three, of the printing stations are arranged on the rotating drum. It may be preferred that all the printing stations are arranged on the rotating drum. When one or more printing station is not arranged on the rotating drum, it may be arranged on an endless rotating horizontal surface.

One or more, for example two or more, or three or more, of the printing station may be flexographic printing station. One or more, for example two or more, or three or more, of the printing station may be digital printing station. The printing system may comprise one or more printing station selected from digital printing station, flexographic printing station, gravure printing station, rotogravure printing station, lithography, porous and screen printing station, letterpress printing station, tampography, and combinations thereof. Preferred for use herein is flexographic printing station.

One or more printing stations may be used to deliver an over polish varnish (OPV), or other printable materials to the film. One or more printing stations may be used to apply a first layer on the film to improve the following printing steps, e.g. to improve the adhesion of the compound such as the ink or dye onto the film. The first layer on the film and/or the OPV can also be applied by other techniques, such as painting.

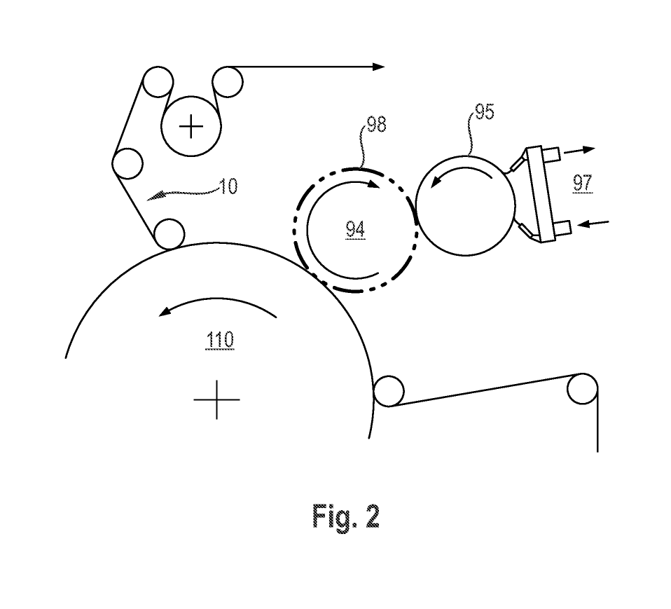

As shown on FIG. 2, the one or more flexographic printing station may comprise a plate cylinder (94) with print cliché (98) (such as print sleeves), an anilox roll (96), a doctor blade (95) and/or an ink pan (97). One or more flexographic printing station may comprise an ink chamber system and a compound delivery system. The compound to be printed chamber blade may distribute homogenously the compound in the anilox cells from the compound delivery system. The plate cylinder may comprise print clichés. One or more of the flexographic station may comprise a plate cylinder with a diameter at least twice as small as the diameter of the rotating drum. For example the plate cylinder may have a diameter comprised between 0.02 and 0.50, or between 0.05 and 0.35 or between 0.10 and 0.20 time the diameter of the rotating drum.

The print cliché can be in the form of a print plate or a print sleeve. The print cliché can be made by light-sensitive polymer where UV light selectively hardens parts of the cliché which will be printing the pattern; though wash cycles the remaining soft non-exposed polymer is washed away. These are generally known as photopolymer plates.

The pattern on the cliché can be laser etched. Another common method for cliché making is by chemical etching a metallic mold, which once prepared will be pressed against the polymer cliché, forming the print cliché.

The print cliché plate may be mounted on the print rolls via double sided tape. The print cliché may be mounted on the sprint rolls via a sleeve system. The sleeve system may allow quick change over between different patterns.

The surface of the print cliché may be modified to enhance the compound to be printed (ink) delivery, both physically and chemically. The surface modification may be physical, for instance increase in local surface roughness and/or oriented micro engravings, with the scope of increasing the compound to be printed extraction from the anilox and deposition on the web. Chemical surface modification includes coating of the print cliché, or adequate choice of the print cliché material to calibrate the surface energy of the adhesion with the printed compound.

The diameter of the plate cylinder may be chosen to be such that the compound residence time is minimum; a large plate cylinder facilitates the drying on the surface of the plates with consequent deterioration of the print quality and precision due to accumulation of dry compound, for example of dry ink.

The nip pressure between the print cliché and the film may be adjusted in both operator side and drive side to achieve the desired quality of print. Higher print pressure will only lead to a minimal higher transfer of compound from the plate, but will increase the overall reliability of the print unit to the risk of running out of contact between the rolls. Excessive pressure amongst the cliché and the impression drum could lead to wear of the plate with loss in print quality.

The choice of the Anilox roll may depend on the compound (e.g. ink) in use. According to one embodiment of the invention, the Anilox roll does not need to have a specific geometry of the engraved cells (Square, Hexagonal, Circular, Pentagonal etc.), as long as the nominal volume the anilox roll can deliver ink is between 1 BCM (billion cubic micrometer) and 15 BCM with LPI (lines per inch) ranging from 50 to 500 LPI. The surface of the anilox roll covered with engraved cells may be between 20 and 70%. The angle defines the angle of the cells in reference to the axis of the printable material transfer roll. Preferably the angle is 30 degrees, 45 degrees or 60 degrees. A 60 degree angle ensures maximum density in a given space. Line count indicates how many cells there are per linear inch. Low line count will allow for a heavy layer of ink to be printed, whereas high line count will permit finer detail in printing. Both cell volume and line count may be closely correlated. For quick change over and clean design a sleeve system may be adopted for the removal and cleaning of the Anilox rolls. The printing system, may be designed such to have the possibility to quick release of the anilox roll sleeves.

The anilox roll diameter may be chosen to be not a multiple of the pitch of the printing cliché, thus increasing the surface usage of the anilox cells. Where the application necessitates the anilox roll may be engraved in bands to deliver the compound only on the portions of the print cliché with the pattern in order to improve the compound performance by reducing the solvent evaporation. The anilox roll may be made by several materials with different engraving techniques. This will give minor differences in the compound delivery to the cliché, due to the different compound affinity. For instance, in the case of a water based ink, a chrome plated mechanically engraved anilox will have a higher transfer efficiency (cell emptying capacity upon contact with the print cliché) versus a standard laser engraved ceramic anilox with the same engraving pattern (BCM, Geometry, surface coverage, etc.).

The nip pressure between the print cliché and the anilox roll can be adjusted in both operator side and drive side to achieve the desired quality of print. Higher print pressure will lead to significant increase in extraction of compound from the anilox roll cells increasing the compound amount transferred to the print cliché and therefore to the web. Excessive pressure amongst the cliché and the anilox roll could lead to wear of the cliché with loss in print quality.

The compound delivery system may consist of a reservoir connected to a chamber blade system by means of piping. The constant solvent evaporation may be compensated by online solvent addition by means of monitoring the compound fluid properties such as viscosity, turbidity, opacity, refractive index, density, etc. Any change in one or more of these properties is compensated by solvent addition to bring the compound to be printed to target.

The chamber blade system may comprise an enclosed chamber with one side opening which clamps on the anilox roll. The blades on the sides of the chamber may guarantee the metered filling of the cells on the anilox roll.

One or more, for example two or more, or three or more of the printing station may be Digital Printing station. Digital printing station includes Continuous Ink Jet (CIJ) and Drop on Demand (DOD), which further divides into Thermal DOD and Piezoelectric DOD.

The digital printing station may comprise a print head, compound supply and a software and electronic controller to control its operability and print location.

Drying/Curing Station

The apparatus may comprise drying/curing station. The drying/curing station may be between two printing stations or after the last printing station. The drying/curing station may be arranged on the rotating drum. The drying/curing station may reduce the drying time.

The drying/curing stations may transmit to the web a heat flux such to dry the compound without modifying the mechanical properties of the PVOH film. As a matter of fact, a too high temperature combined with a long residence time in the drying station might melt the film or compromise entirely all the downstream operations. Temperature to be used for the drying stage can vary from 5° C. to 70° C. with relative humidity below 80%, the residence time may be adjusted accordingly.

The drying/curing stations may take place by means of radiation, such as UV light.

Control System (Registration Sensors and Adjustment System)

The apparatus may comprise a control system for monitoring and adjusting the registration between the different printing stations. The apparatus may comprise a registration sensor and/or an adjustment system for monitoring and adjusting the registration between the plurality of separate printing stations. The registration between the different printing stations can be detected by registration sensors (102, 103), which may for example identify a specific registration marks on the film for each color measured, and adjusting the setting of the printing stations accordingly. Other methods of registration also include vision systems (104) which acquire the image of the printed pattern and compare it to a reference pattern.

When the apparatus comprise a pouch making unit (e.g. as seen on FIG. 1), the apparatus may comprise a control system for monitoring. The control system typically comprises at least one registration sensor (102, 103, 104, 105, 106, 107, 108) for monitoring the registration between the pouch and the printed pattern and at least one adjustment system (61, 62, 64, 110, 81, 82, 83) for adjusting the position of the pattern onto the pouches.

The sources of variability in the process are principally due to raw material properties variability (i.e. elastic modulus, creep, material thickness etc.) and equipment variability (wear of idlers, tension spikes due to idler blockage, incorrect material transformations etc.). The control system as it is described herein in its various options will compensate for any process variability with the goal of maintaining a good registration between the printed pattern and the pouch-making process and/or insuring a good registration between the parts of the printed pattern which have been printed by different printing stations (typically color to color registration).

Typically, the drum 110 and, when present, the conveyor belt 130 are not the preferred adjustment system. Modifying the speed of the conveyor belt would impact the production speed.

Adjustment system (61) before the printing stations to adjust the registration between the pouches and the printed pattern are typically only useful if the film is already partially printed. The registration can be maintained in phase by repositioning of the cliché rolls on the print unit (81, 82, 83): the signal from the registration sensor is used to reposition either simultaneously the 3 print rolls to recover the miss registration. An alternative mean of registration using the cliché rolls is to adjust the first printing station to match the registration of an endless rotating system, and utilize the color to color sensor in FIGS. 1 (102 and 103) to adjust the position of the consecutive print rolls.

The apparatus of the invention has capability to adjust the position of the printed pattern to the pouch-making process (when present) in several ways. The optimal registration method depends on the film path between the printed pattern and the pouch-making unit. All the registration operations which happen upstream have a delay time. One or more of the registration method may be used.

A possible registration system feature is the use of a printed pattern, for example a square in correspondence of the printed pattern, as a registration marker (some very simple printed pattern can be used also as markers). The passage of the marker symbol under a registration sensor (102, 103, 104, 105, 106, 107, 108) may be used to measure the time interval between consecutive elements of the printed pattern in the pouch-making unit or to measure the difference in time stamp between the position of the pattern versus the reference time stamp of the endless rotating system (130). The registration sensor, for example, could be a Sick contrast sensor KT10W-2P 1115 or KTM-WP117A1P.

The signal given by a registration sensor may be fed back to the printing stations which by changing the speed of the print roll (81, 82, 83) to rephase the pattern printed. The registration of the printed pattern may be adjusted differently depending of the nature of the printing stations. When flexographic printing is used, the position of the plate cylinder may be shifted. When digital printing is used the timing of the droplet firing may be adjusted.

The signal given by a registration sensor may be fed back to an adjustment system such as a driven roller or an endless rotating system. Without wishing to be bound by theory, with this approach the web is stretched upstream of the driven roller and this enables an immediate correction of the image position relative to the converter. This corrections is proportional to the length of the span and the relative speed of the driven roll, relative to the previous metering roll.

The speed and tension of the film during the process and the registration of the printed pattern may be guaranteed and controlled by different means including the following ones.

The tension of the film may be adjusted by modifying the unwinder dancer (51) tension. The tension on the unwinder may be increased by adding weight or pneumatic pressure on the dancer; this has the effect of increasing the tension to the whole downstream transformations.

The tension of the film may be adjusted by modifying the speed of an in-feed driven roller (61). The in-feed driven roller may comprise one or more motorized roller or a nip-roll. The change of speed of an in-feed driven roller will result either in a stable tension gain or tension loss. Given no speed difference or localized tension increases downstream of the printing system, this in-feed tension change should not affect the phase and pitch of the printed pattern on the film.

The speed of an endless rotating system may be adjusted. A change of the rotating speed of the rotating drum versus the endless rotating system of the pouch making unit, will result in a change of pitch of the printed pattern. For a strain induced by running with different speeds, the diameter of the print cliché should be scaled accordingly by shrinking the printed pattern by the same percentage difference imposed in the line speed change of the rotating drum. The overall printing process (including in-feed driven roller, the printing system and the rotating drum) can be slowed down or sped up to adjust the registration between the registration clock of the printed pattern and the pouch making unit.

The printed pattern can be registered with the pouch-making unit by speed adjustment of an out-feed driven roller before the pouch-making unit (62, 64). The tension of the film may be adjusted by modifying the speed of an out-feed driven roller (62, 64). The out-feed driven roller may comprise one or more motorized roller or nip roll. Any change done on an out-feed driven roller, has the same effect of pattern pitch as the change in the drum rotating speed and a revision of the diameter of the print roll should be done to compensate for the stretch of the film.

The Film

The film to be printed comprises a resin comprising polyvinyl alcohol (PVOH) or a copolymer thereof. The film of the present invention is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns:

50 grams±0.1 gram of film material is added in a pre-weighed 400 ml beaker and 245 ml±1 ml of distilled water is added. This is stirred vigorously on a magnetic stirrer, labline model No. 1250 or equivalent and 5 cm magnetic stirrer, set at 600 rpm, for 30 minutes at 24° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

The film comprises a polymeric material comprising PVOH or a copolymer thereof. The film may comprise from 10% by weight of PVOH or a copolymer thereof, for example from 30% to 100%, or at least 50%, or at least 70% or at least 90% by weight of PVOH or a copolymer thereof. The film material may be obtained by casting, blow-moulding, extrusion or blown extrusion of the polymeric material, as known in the art. The film may comprise further polymeric material(s).

Further polymeric materials include polymers, copolymers or derivatives thereof suitable for use as pouch material such as, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. Further polymeric materials include polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and hydroxypropyl methyl cellulose (HPMC), and combinations thereof. Preferably, the level of polymer in the pouch material, is at least 60% by weight. The polymer can have any weight average molecular weight, preferably from about 1000 to 1,000,000, more preferably from about 10,000 to 300,000 yet more preferably from about 20,000 to 150,000.

Use of mixtures of polymers may be beneficial to control the mechanical and/or dissolution properties of the pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred films exhibit good dissolution in cold water, meaning unheated distilled water. Preferably such films exhibit good dissolution at temperatures 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310, films described in U.S. Pat. No. 6,166,117 and U.S. Pat. No. 6,787,512 and PVA films of corresponding solubility and deformability characteristics. Further preferred films are those described in US2006/0213801, WO 2010/119022 and U.S. Pat. No. 6,787,512.

The water soluble film comprises a resin comprising one or more PVA polymers or copolymer thereof. Preferably said water soluble film resin comprises a blend of PVA polymers. For example, the PVA resin can include at least two PVA polymers, wherein as used herein the first PVA polymer has a viscosity less than the second PVA polymer. A first PVA polymer can have a viscosity of at least 8 centipoise (cP), 10 cP, 12 cP, or 13 cP and at most 40 cP, 20 cP, 15 cP, or 13 cP, for example in a range of about 8 cP to about 40 cP, or 10 cP to about 20 cP, or about 10 cP to about 15 cP, or about 12 cP to about 14 cP, or 13 cP. Furthermore, a second PVA polymer can have a viscosity of at least about 10 cP, 20 cP, or 22 cP and at most about 40 cP, 30 cP, 25 cP, or 24 cP, for example in a range of about 10 cP to about 40 cP, or 20 to about 30 cP, or about 20 to about 25 cP, or about 22 to about 24, or about 23 cP. The viscosity of a PVA polymer is determined by measuring a freshly made solution using a Brookfield LV type viscometer with UL adapter as described in British Standard EN ISO 15023-22006 Annex E Brookfield Test method. It is international practice to state the viscosity of 4% aqueous polyvinyl alcohol solutions at 20° C. All viscosities specified herein in cP should be understood to refer to the viscosity of 4% aqueous polyvinyl alcohol solution at 20° C., unless specified otherwise. Similarly, when a resin is described as having (or not having) a particular viscosity, unless specified otherwise, it is intended that the specified viscosity is the average viscosity for the resin, which inherently has a corresponding molecular weight distribution.

The individual PVA polymers may have any suitable degree of hydrolysis, as long as the degree of hydrolysis of the PVA resin is within the ranges described herein. Optionally, the PVA resin may, in addition or in the alternative, include a first PVA polymer that has a Mw in a range of about 50,000 to about 300,000 Daltons, or about 60,000 to about 150,000 Daltons; and a second PVA polymer that has a Mw in a range of about 60,000 to about 300,000 Daltons, or about 80,000 to about 250,000 Daltons.

The PVA resin may still further include one or more additional PVA polymers that have a viscosity in a range of about 10 to about 40 cP and a degree of hydrolysis in a range of about 84% to about 92%.

When the PVA resin includes a first PVA polymer having an average viscosity less than about 11 cP and a polydispersity index in a range of about 1.8 to about 2.3, then in one type of embodiment the PVA resin contains less than about 30 wt % of the first PVA polymer. Similarly, when the PVA resin includes a first PVA polymer having an average viscosity less than about 11 cP and a polydispersity index in a range of about 1.8 to about 2.3, then in another, non-exclusive type of embodiment the PVA resin contains less than about 30 wt % of a PVA polymer having a Mw less than about 70,000 Daltons.

Of the total PVA resin content in the film described herein, the PVA resin can comprise about 30 to about 85 wt. % of the first PVA polymer, or about 45 to about 55 wt. % of the first PVA polymer. For example, the PVA resin can contain about 50 wt. % of each PVA polymer, wherein the viscosity of the first PVA polymer is about 13 cP and the viscosity of the second PVA polymer is about 23 cP.

One type of embodiment is characterized by the PVA resin including about 40 to about 85 wt % of a first PVA polymer that has a viscosity in a range of about 10 to about 15 cP and a degree of hydrolysis in a range of about 84% to about 92%. Another type of embodiment is characterized by the PVA resin including about 45 to about 55 wt % of the first PVA polymer that has a viscosity in a range of about 10 to about 15 cP and a degree of hydrolysis in a range of about 84% to about 92%. The PVA resin can include about 15 to about 60 wt % of the second PVA polymer that has a viscosity in a range of about 20 to about 25 cP and a degree of hydrolysis in a range of about 84% to about 92%. One contemplated class of embodiments is characterized by the PVA resin including about 45 to about 55 wt % of the second PVA polymer.

When the PVA resin includes a plurality of PVA polymers the PDI value of the PVA resin is greater than the PDI value of any individual, included PVA polymer. Optionally, the PDI value of the PVA resin is greater than 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.5, or 5.0.

Preferably the PVA resin that has a weighted, average degree of hydrolysis ( H̅°̅) between about 80 and about 92%, or between about 83 and about 90%, or about 85 and 89%. For example, H̅°̅ for a PVA resin that comprises two or more PVA polymers is calculated by the formula H̅°̅=Σ(Wi·Hᵢ) where Wi is the weight percentage of the respective PVA polymer and a Hi is the respective degrees of hydrolysis. Still further it is desirable to choose a PVA resin that has a weighted log viscosity ( μ̅) between about 10 and about 25, or between about 12 and 22, or between about 13.5 and about 20. The μ̅ for a PVA resin that comprises two or more PVA polymers is calculated by the formula μ̅=e^{ΣW}^{ᵢ}^{·ln μ}^{ᵢ} where μᵢ is the viscosity for the respective PVA polymers.

Yet further, it is desirable to choose a PVA resin that has a Resin Selection Index (RSI) in a range of 0.255 to 0.315, or 0.260 to 0.310, or 0.265 to 0.305, or 0.270 to 0.300, or 0.275 to 0.295, preferably 0.270 to 0.300. The RSI is calculated by the formula; Σ(Wᵢ|μᵢ−μₜ|)/Σ(Wᵢμᵢ), wherein μₜ is seventeen, μᵢ is the average viscosity each of the respective PVOH polymers, and Wᵢ is the weight percentage of the respective PVOH polymers. Even more preferred films are water soluble copolymer films comprising a least one negatively modified monomer with the following formula:

[Y]−[G]n

wherein Y represents a vinyl alcohol monomer and G represents a monomer comprising an anionic group and the index n is an integer of from 1 to 3. G can be any suitable comonomer capable of carrying of carrying the anionic group, more preferably G is a carboxylic acid. G is preferably selected from the group consisting of maleic acid, itaconic acid, coAMPS, acrylic acid, vinyl acetic acid, vinyl sulfonic acid, allyl sulfonic acid, ethylene sulfonic acid, 2 acrylamido 1 methyl propane sulfonic acid, 2 acrylamido 2 methyl propane sulfonic acid, 2 methyl acrylamido 2 methyl propane sulfonic acid and mixtures thereof.
The anionic group of G is preferably selected from the group consisting of OSO₃M, SO₃M, CO₂M, OCO₂M, OPO₃M₂, OPO₃HM and OPO₂M. More preferably anionic group of G is selected from the group consisting of OSO₃M, SO₃M, CO₂M, and OCO₂M. Most preferably the anionic group of G is selected from the group consisting of SO₃M and CO₂M.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including surfactant, to be delivered to the wash water, for example organic polymeric dispersants, etc.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

The Pouch

The printed film obtained by the apparatus of the invention may be used to make a water-soluble pouch. The pouch may be made at the pouch-making unit.

The pouches may be single or multi-compartment pouches. The pouch may form a compartment comprising a composition. The composition may be comprised within the compartment and is enclosed by the film. The composition may be at least partially enclosed by the water-soluble film on which a pattern is printed, said pattern being on the side of the film facing the inside or the outside of the pouches.

Where the pouch is a multi-compartment pouch, the compartments preferably have a different aesthetic appearance. A difference in aesthetics can be achieved in any suitable way. One compartment of the pouch may be made using translucent, transparent, semi-transparent, opaque or semi-opaque film, and the second compartment of the pouch may be made using a different film selected from translucent, transparent, semi-transparent, opaque or semi-opaque film such that the appearance of the compartments is different. The compartments of the pouch may be the same size or volume. Alternatively the compartments of the pouch may have different sizes, with different internal volumes. The compartments may also be different from one another in terms of texture or colour. Hence one compartment may be glossy whilst the other is matt. This can be readily achieved as one side of a water-soluble film is often glossy, whilst the other has a matt finish. The films may be transparent or translucent and the composition contained within may be coloured. Thus in a preferred embodiment of the present invention a first compartment has a colour selected from the group consisting of white, green, blue, orange, red, yellow, pink or purple and a second compartment has a different colour selected from the group consisting of white, yellow, orange, blue or green.

The compartments of a multi-compartment pouch can be separate, but are preferably conjoined in any suitable manner. Most preferably the second and optionally third or subsequent compartments are superimposed on the first compartment. In one embodiment, the third compartment may be superimposed on the second compartment, which is in turn superimposed on the first compartment in a sandwich configuration. Alternatively the second and third, and optionally subsequent, compartments may all be superimposed on the first compartment. However it is also equally envisaged that the first, second and optionally third and subsequent compartments may be attached to one another in a side by side relationship. In a preferred embodiment the present pouch comprises three compartments consisting of a large and two smaller compartments. The second and third smaller compartments are superposed on the first larger compartment. Alternatively, second, third and fourth smaller compartments may be superposed onto the larger compartment. The size and geometry of the compartments are chosen such that this arrangement is achievable.

The geometry of the compartments may be the same or different. In a preferred embodiment the second and optionally third or subsequent compartment has a different geometry and shape to the first compartment. In this embodiment the second and optionally third compartments are arranged in a design on the first compartment. Said design may be decorative, educative, illustrative for example to illustrate a concept or instruction, or used to indicate origin of the product. In a preferred embodiment the first compartment is the largest compartment having two large faces sealed around the perimeter. The second compartment is smaller covering less than 75%, more preferably less than 50% of the surface area of one face of the first compartment. In the embodiment wherein there is a third compartment, the above structure is the same but the second and third compartments cover less than 60%, more preferably less than 50%, even more preferably less than 45% of the surface area of one face of the first compartment.

The pouch may comprise a single film, which is sealed to itself. Alternatively, the pouch may comprise at least two films which are sealed to each other.

The pouches may be packaged in an outer package. Said outer package may be a see-through or partially see-through container, for example a transparent or translucent bag, tub, carton or bottle. The pack can be made of plastic or any other suitable material, provided the material is strong enough to protect the pouches during transport. This kind of pack is also very useful because the user does not need to open the pack to see how many pouches there are left. Alternatively, the pack can have non-see-through outer packaging, perhaps with indicia or artwork representing the visually-distinctive contents of the pack.

The pouches of the present invention are suitable for cleaning applications, particularly laundry or dishwashing applications. The pouches are suitable for hand or machine washing conditions. When machine washing, the pouch may be delivered from the dispensing drawer or may be added directly into the washing machine drum.

The pouch may comprise from 5 g to 50 g, for example from 15 g to 50 g, or from 25 g to 50 g of composition.

The Composition

The composition may be a liquid, or a solid or a tablet. By the term ‘liquid’ it is meant to include liquid, paste, waxy or gel compositions. The liquid composition may comprise a solid. Solids may include powder or agglomerates, such as micro-capsules, beads, noodles or one or more pearlised balls or mixtures thereof. Such a solid element may provide a technical benefit, through the wash or as a pre-treat, delayed or sequential release component. Alternatively it may provide an aesthetic effect. The compositions of the present invention may comprise one or more of the ingredients discussed below.

The composition may comprise a surfactant. The total surfactant level may be in the range of from about 1% to 80% by weight of the composition. The surfactants utilized can be of the anionic, nonionic, zwitterionic, ampholytic, semi-polar or cationic type or can comprise compatible mixtures of these types. More preferably surfactants are selected from the group consisting of anionic, nonionic, cationic surfactants and mixtures thereof. Detergent surfactants useful herein are described in U.S. Pat. No. 3,664,961, Norris, issued May 23, 1972, U.S. Pat. No. 3,919,678, Laughlin et al., issued Dec. 30, 1975, U.S. Pat. No. 4,222,905, Cockrell, issued Sep. 16, 1980, and in U.S. Pat. No. 4,239,659, Murphy, issued Dec. 16, 1980.

The composition may comprise a rheology modifier, a builder, a bleaching system, a bleach activator, a bleach catalyst, and/or enzymes.

The compositions may comprise a fabric care benefit agent. As used herein, “fabric care benefit agent” refers to any material that can provide fabric care benefits such as fabric softening, color protection, pill/fuzz reduction, anti-abrasion, anti-wrinkle, and the like to garments and fabrics, particularly on cotton and cotton-rich garments and fabrics, when an adequate amount of the material is present on the garment/fabric. Non-limiting examples of fabric care benefit agents include cationic surfactants, silicones, polyolefin waxes, latexes, oily sugar derivatives, cationic polysaccharides, polyurethanes, fatty acids and mixtures thereof. Fabric care benefit agents when present in the composition, are suitably at levels of up to about 30% by weight of the composition, more typically from about 1% to about 20%, preferably from about 2% to about 10%.

The compositions may comprise an automatic dishwashing care benefit agent. As used herein, “automatic dishwashing care benefit agent” refers to any material that can provide shine, fast drying, metal, glass or plastic protection benefits. Non-limiting examples of automatic dishwashing care benefit agents include organic shine polymers, especially sulfonated/carboxylated polymers, surface modifying polymers or surfactants inducing fast drying, metal care agents like benzatriazoles and metal salts including Zinc salts, and anti-corrosion agents including silicates e.g. sodium silicate.

The composition may comprise a suitable cleaning adjunct material, including, but are not limited to; enzyme stabilizing systems; antioxidants, opacifier, pearlescent agent, hueing dye, scavenging agents including fixing agents for anionic dyes, complexing agents for anionic surfactants, and mixtures thereof; optical brighteners or fluorescers; soil release polymers; dispersants; suds suppressors; dyes; colorants; hydrotropes such as toluenesulfonates, cumenesulfonates and naphthalenesulfonates; color speckles; perfumes and perfume microcapsules, colored beads, spheres or extrudates; clay softening agents, alkalinity sources and mixtures thereof.

Pouch-Making Unit

The apparatus may comprise a pouch making unit. The pouch making unit is the place where the process for making the pouch takes place. The pouch making unit may comprise a filling system to form pouches from the printed film, an additional layer of film and a composition. The pouch making unit of the apparatus may comprise an endless rotating system such as a conveyor or a drum. The printed film may be hold onto the endless rotating system at a lay down point (140). Pouches may be formed and filled while conveyed on an endless rotating system. Relative changes of speed between the endless rotating system and the other elements of the apparatus allow adjustment in registration between the position of the printed pattern and the pouch.

The process for making the pouch may be continuous or intermittent. The process comprises the general steps of forming an open pouch, preferably by forming a water-soluble film into a mould to form said open pouch, filling the open pouch with a composition, closing the open pouch filled with the composition, preferably using a second water-soluble film to form the pouch. The second film may also comprise compartments, which may or may not comprise compositions. Alternatively, the second film may be a second closed pouch containing one or more compartments, used to close the open pouch. Preferably, the process is one in which a web of pouches are made, said web is then cut to form individual pouches.

Alternatively, the first film may be formed into an open pouch comprising more than one compartment. In which case, the compartments formed from the first pouch may be in a side-by-side or ‘tyre and rim’ orientation. The second film may also comprise compartments, which may or may not comprise compositions. Alternatively, the second film may be a second closed pouch used to close the multicompartment open pouch.

Alternatively, the compartments may all be positioned in a side-by-side arrangement. In such an arrangement the compartments may be connected to one another and share a dividing wall, or may be substantially separated and simple held together by a connector or bridge. Alternatively, the compartments may be arranged in a ‘tyre and rim’ orientation, i.e. a first compartment is positioned next to a second compartment, but the first compartment at least partially surrounds the second compartment, but does not completely enclose the second compartment.

The unit dose article and/or at least one of its compartments may have a substantially, square, rectangular, oval, elliptoid, superelliptical, circular shape shape, or any other suitable shape fitting for its application. The shape may or may not include any excess material present as a flange or skirt at the point where two or more films are sealed together. By substantially, we herein mean that the shape has an overall impression of being for example square. It may have rounded corners and/or non-straight sides, but overall it gives the impression of being square for example.

The pouch may be made by thermoforming, vacuum-forming or a combination thereof. pouches may be sealed using any sealing method known in the art. Suitable sealing methods may include heat sealing, solvent sealing, pressure sealing, ultrasonic sealing, laser sealing or a combination thereof.

The pouch may be dusted with a dusting agent. Dusting agents can include talc, silica, zeolite, carbonate or mixtures thereof.

An exemplary means of making the pouch of the present invention is a continuous process for making a pouch, comprising the steps of:

a. continuously feeding a the printed water-soluble film onto a horizontal portion of an endless rotating system, which comprises a plurality of moulds, or onto a non-horizontal portion thereof and continuously moving the film to said horizontal portion;

b. forming from the film on the horizontal portion of the endless rotating system, and in the moulds on the surface, a continuously moving, horizontally positioned web of open pouches;

c. filling the continuously moving, horizontally positioned web of open pouches with a composition, to obtain a horizontally positioned web of open, filled pouches;

d. preferably continuously, closing the web of open pouches, to obtain closed pouches, preferably by feeding an additional water-soluble film onto the horizontally positioned web of open, filed pouches, to obtain closed pouches; and

e. optionally sealing the closed pouches to obtain a web of closed pouches.

The additional water-soluble film may comprise at least one open or closed compartment.

In one embodiment, a printed film is combined with an additional film preferably wherein the printed and additional film are brought together and sealed together via a suitable means, and preferably wherein the additional film is a rotating drum set-up. In such a set-up, pouches are filled at the top of the drum and preferably sealed afterwards with a layer of film, the closed pouches come down to meet the printed film of pouches, preferably open pouches, formed preferably on a horizontal forming surface. It has been found especially suitable to place the rotating drum unit above the horizontal forming surface unit.

Preferably, the resultant film of closed pouches are cut to produce individual pouches. Preferably, the distance between the lay down point (140) and the registration sensor for monitoring the position of the pattern onto the pouches is as short as possible. Preferably, the distance between the lay down point and the mean for adjusting the position of the pattern onto the pouches is as short as possible. Preferably, the distance between the registration sensor for monitoring the position of the pattern onto the pouches and the mean for adjusting the position of the pattern onto the pouches is as short as possible.

The distance (d1) between the lay down point (140) and the registration sensor (e.g. 106) for monitoring the position of the pattern onto the pouches may be lower than 5 meters, preferably lower than 2 m, between 1 cm and 1 m or between 2 cm and 50 cm or between 5 cm and 25 cm.

The distance (d2) between the lay down point (140) and the adjustment system (e.g. 64) for adjusting the position of the pattern onto the pouches may be lower than 5 meters, preferably lower than 2 m, between 1 cm and 1 m or between 2 cm and 50 cm or between 5 cm and 25 cm.

The distance (d3) between the registration sensor (e.g. 106) for monitoring the position of the pattern onto the pouches and the adjustment system (e.g. 64) for adjusting the position of the pattern onto the pouches may be lower than 5 meters, preferably lower than 2 m, between 1 cm and 1 m or between 2 cm and 50 cm or between 5 cm and 25 cm.

The distances d1, d2, and d3 respectively refer to the film path length between the registration sensor, the adjustment system, and the lay down point.

The overall span length corresponds to the longest film path length between d1, d2, and d3. The overall span length is also equal to (d1+d2+d3)/2. The longer the overall span length, the longer the times it takes for the registration operation to take place.

The sum d1+d2+d3 may be lower than the distance (d4) between the lay down point and the roll (21). The ratio (d1+d2+d3)/d4 may be lower than 0.5 or lower than 0.2 or lower than 0.1.

The Compound to be Printed

The printed pattern may comprise text elements, images, symbols. The printed pattern may comprise a printed compound.

The compound to be printed is typically an ink.

The ink for printing onto the film has preferably a desired dispersion grade in water. The ink may be of any color including white, red, and black. The ink may be a water-based ink comprising from 10% to 80% or from 20% to 60% or from 25% to 45% per weight of solid. The ink may comprise from 20% to 90% or from 40% to 80% or from 50% to 75% per weight of water.

The ink may have a viscosity measured at 20° C. with a shear rate of 1000 s⁻¹ between 1 and 600 cPs or between 50 and 350 cPs or between 100 and 300 cPs or between 150 and 250 cPs. The measurement may be obtained with a cone-plate geometry on a TA instruments AR-550 Rheometer.

All percentages, ratios and proportions used herein are by weight percent of the composition, unless otherwise specified. All average values are calculated “by weight” of the composition or components thereof, unless otherwise expressly indicated.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Apparatus for producing a printed film, the apparatus comprising:
a roll of water-soluble film to be printed, the film comprising a resin comprising polyvinyl alcohol (PVOH) or a copolymer thereof,
a rotating drum,
a printing system for printing a printed pattern onto the film, the printing system comprising a plurality of separate printing stations arranged on the rotating drum.

2. Apparatus according to claim 1, further comprising a control system for monitoring and adjusting the registration between the plurality of separate printing stations.

3. Apparatus according to claim 1, further comprising a filling system to form pouches from the printed film.

4. Apparatus according to claim 3, comprising a control system comprising a registration sensor for monitoring the registration between the pouch and the printed pattern and at least one adjustment system for adjusting the position of the pattern onto the pouch.

5. Apparatus according to claim 3, wherein the pouches comprise from about 15 g to about 50 g of composition.

6. Apparatus according to claim 3, wherein the pouches form a compartment comprising the composition at least partially enclosed by the water-soluble film on which a pattern is printed, said pattern being on the side of the film facing the inside of the pouches.

7. Apparatus according to claim 1, wherein at least one of the printing stations is a flexographic printing station.

8. A printed film made with the apparatus of claim 1.
